(19) United States
(12) Patent Application Publication
(10) Pub. No.: US 2008/0017123 A1
(43) Pub. Date: Jan. 24, 2008

(54) Pet box with rotational litter sifting screen and disposal receptacle

(76) Inventor: Bryan Nicholas Chin, Costa Mesa, CA (US)

Correspondence Address: PATENT LAW & VENTURE GROUP, 2424 S.E. BRISTOL, SUITE 300, NEWPORT BEACH, CA, 92660, US

(21) Appl. No.: 11/880,266

(22) Filed: Jul. 20, 2007

Related U.S. Application Data
(60) Provisional application No. 60/832,859, filed on Jul. 24, 2006.

(51) Int. Cl. A01K 29/00

(52) U.S. Cl. 119/166

(57) ABSTRACT

An improved sanitary facility for pets for the collecting, removing and disposing of small animal excrement without the attendant mess and odor heretofore experienced, uses a rotatable chamber which contains pet litter, sand or other suitable material. A first opening is provided for animal ingress and egress, and a second opening for expulsion of separated waste. Filter means, disposed circumferentially within the chamber, selectively separate solid excrement and agglomerated matter from unsoiled litter as the chamber is rotated. The separated waste is urged, by the action of gravity on the inclined filter means, toward a sealable second opening in the chamber. The separated matter is expelled from the chamber through the second opening and deposited in an attached receptacle. The media's weight prevents rotation of the chamber during use by the animal. Means are also provided for automatically sealing the second opening to prevent odor from escaping the chamber.

### CROSS-REFERENCE TO RELATED APPLICATIONS

This application is a non-provisional application describing the same invention as a currently active provisional application Ser. No. 60/832,859, filed on Jul. 24, 2006, and the present non-provisional hereby claiming date priority therefrom.

### STATEMENT REGARDING FEDERALLY SPONSORED RESEARCH OR DEVELOPMENT

Not applicable.

The Names of the Parties to a Joint Research Agreement

Not applicable.

### INCORPORATION-BY-REFERENCE OF MATERIAL SUBMITTTED ON A COMPACT DISC

Not applicable.

### REFERENCE TO A “MICROFICHE APPENDIX”

Not applicable.

### BACKGROUND OF THE INVENTION

1. Field of the Present Disclosure

This disclosure relates generally to animal litter boxes and more particularly to the type of litter box that is rotated for segregating waste materials from clean litter.

2. Description of Related Art Including Information Disclosed Under 37 CFR 1.97 and 1.98

Carter, U.S. Pat. No. 4,120,264, discloses an improved sanitary facility for pets for the collecting, removing and disposing of small animal excrement without the attendant mess and odor heretofore experienced. A rotatable chamber which contains pet litter, sand or other suitable material has a first closeable opening for animal ingress and egress, and a second opening for expulsion of separated waste. Filter means, disposed circumferentially within the chamber, selectively separate solid excrement and agglomerated matter from unsoiled litter as the chamber is rotated. The separated waste is continuously urged, by the combined action of gravity and the incline of the filter means, toward a second sealable opening in the chamber. The separated matter is expelled from the chamber through the second opening and deposited in an appropriate receptacle. Means are provided to prevent rotation of the chamber during use by the animal. Means are also provided for automatically sealing the second opening to prevent odor from escaping the chamber.

Pierson, Jr., U.S. Pat. No. 4,846,104, discloses an apparatus for mechanical separation of cat solid waste, randomly buried in cat litter, and cat urine saturated litter clump waste from surrounding clean cat litter and mechanically removing the waste to storage, the apparatus including: a support including a waste collection region; a circular housing that is rotatably mounted about its axis on the support over the waste collection region, the housing having an opening in its periphery for passage of a cat when in a first rotational position and for passage of the solid waste and litter clump waste when in a second, downwardly directed, rotational position over the waste storage region; a solid partition extending inwardly from the periphery at a location adjacent to the opening so as to trap litter on the side opposite of the solid partition from the opening when the opening is in the second rotational position; a screen that retains the solid waste and litter clump waste, the screen extending inwardly from the periphery at a location spaced from the solid partition so as to pass through the litter as the housing is rotated in a manner that causes the opening to move from the first rotational position to the second rotational position, whereby when the housing rotates through a complete revolution, the solid waste and litter clumps are automatically discharged through the opening into the waste collection region, the litter is automatically sifted and aerated by passing twice through the screen, and the litter is retained in the housing.

Shirley, U.S. Pat. No. 5,048,464, discloses a litter system that includes a chamber for containing a quantity of particulate litter. The chamber includes front and rear walls, the front wall thereof including an aperture providing an entry way to the chamber for an animal. A helical shaped screen is disposed within the chamber and extends from adjacent the front end to adjacent the rear end of the chamber for separating the litter from animal waste and for transporting the animal waste through the chamber. Structure is provided for rotating the chamber, such that animal waste is transported through the chamber as the chamber rotates.

LaRoche, U.S. Pat. No. 5,107,797, discloses a litter box that includes a rotatable enclosure having at least one access opening for a domestic animal and a rake disposed on its inner surface, a motor for selectably rotating the enclosure, and a receptacle disposed within the enclosure and movable between a first position generally against the inner surface of the enclosure, and a second position which is nearly vertically disposed within the enclosure. In operation, the receptacle is extended to an operative position, and the enclosure is rotated so that the rake will separate relatively large particles of solid excrement from the litter for deposit into the receptacle. The receptacle is then retracted to its initial, rest position. The litter box may further operate to detect the presence of a domestic animal within the enclosure, and to initiate rotation of the enclosure when the domestic animal leaves the enclosure, to provide for fully automated operation of the litter box.

Hoeschen, U.S. Pat. No. 5,509,379, discloses an animal litter box for automatically separating waste materials from animal litter. A rotating cylinder is provided with an internal surface for receiving the animal litter and waste materials. A perforated surface has one end fixed to the internal surface of the rotating cylinder so that as the cylinder is rotated, the animal litter and waste materials fall onto the perforated surface. The perforated surface includes openings sized to permit the animal litter to fall through the perforated surface and sized to capture the waste materials upon the perforated surface. A collection assembly is coupled to the perforated surface so that as the rotating cylinder continues to rotate, the waste materials supported on the perforated surface are guided to the collection assembly and are thereafter conducted to a waste reservoir. After the rotating cylinder has been rotated 360 degrees, the waste has been separated from the animal litter and is stored in the reservoir with the animal litter ready to receive new kitty urine and solid waste materials.

Flores, U.S. Pat. No. 5,551,375, discloses a pet waste box for collecting waste deposited by a pet, and for subsequent removal and disposal of the pet waste. The waste box comprises a housing including opposed first and second sidewalls, opposed front and back walls, and opposed top and bottom walls, an interior space defined by the walls for retaining pet litter and pet waste, a first opening through which a pet may enter and exit the housing, a second opening, and a structure for supporting the housing for rotation about a horizontal axis. The housing also includes a structure for closing the first opening, and a removable drawer received through the second opening and having a waste separation screen and a waste retaining partition. The screen and the partition are positioned within the housing so that, as the housing is rotated through one revolution, the screen separates the waste from the litter, and the waste is retained between the partition and the screen. The waste is then disposed by removing the drawer from the housing, and emptying the waste into an appropriate receptacle.

Page, U.S. Pat. No. 5,752,465, discloses an animal litter device that includes a chamber that is rotatable about a generally horizontal axis, the chamber having a first-rotation position and a second-rotation position. An internal portion of the chamber is disposed at a bottom of the chamber when the chamber is in the its first rotation position whereat the chamber is usable by an animal, and this internal portion of the chamber is disposed generally at a top of the chamber when the chamber is in its second rotation position whereat the chamber is not usable by an animal. A dump opening is located at a second portion of the chamber, the dump opening being located at or near a top of the chamber when the chamber is in its first-rotation position, and being located at a bottom of the chamber when the chamber is in its second-rotatable position. A moisture impervious, flexible and weighted liner has boarder portions thereof fixed to the interior of the chamber, and has a weighted mid-portion covering the internal portion of the chamber and movable relative thereto. A mass of litter loosely sits on the flexible liner when the chamber is in its first rotation position. Waste separation means within the chamber operates when the chamber is rotated in a first direction between its first-rotatable position and its second-rotatable position to separate animal waste from the mass of litter, whereupon the separated animal waste exits the chamber by way of the waste opening. When the chamber is rotated in a second direction between its first-rotatable position and its second-rotatable position, the mass of litter to exits the chamber by way of the exit opening.

Emery, U.S. Pat. No. 6,234,112, discloses a self-cleaning pet litter box assembly that automatically separates clumped material from unclumped pet litter and disposes of it. The assembly comprises a base member, an open-top pet litter container rotatably mounted on the base member, a motor, a sieve member and a conveyor. The pet litter container is substantially filled with pet litter. It is for use by a pet, particularly a cat. The pet litter container rotates about the base member so that clumped and unclumped material in the container is moved into contact with the sieve member. Clumped material is separated out by the sieve and conveyed away to a waste receptacle. The waste receptacle must be periodically emptied or replaced with another waste receptacle, but typically only about once a week.

Sugahara, U.S. Pat. No. 6,286,457, discloses a self-cleaning cat litter box that has the ability to automatically filter and separate clumped soiled litter and fecal matter from clean litter. The apparatus includes a rotatable drum, a spiral filter within the drum, and a stationary back plate. The drum has front and back walls, and the front wall has a front opening which permits access and egress by a domestic pet. The back wall has a first opening for both the removal of soiled litter and the addition of clean litter. The spiral filter is slotted, and is mounted on the inner surface of the drum. The stationary back plate is parallel to the plane of the back wall and has a second opening which permits the passage of soiled litter away from the drum, and a third opening to permit the passage of clean litter into the drum. The drum is rotated by a suitable drive, which can be electively actuated by a switch. The filter is configured to act as a scoop, and when the drum is at its rest position the filter is at least 10 degrees from the bottommost point on the drum. When the second opening is aligned with the first opening, passage of soiled litter from the filter into disposable collection means occurs. When the third opening is aligned with the first opening, passage of clean litter into the drum from a reservoir mounted on the back of the back plate will occur. A domestic pet includes a cat, rabbit, ferret, or skunk.

Reitz, U.S. Pat. No. 6,463,881, discloses an animal litter device that includes a chamber that is rotatable about a generally horizontal axis, the chamber having a first-rotation position and a second-rotation position. An internal portion of the chamber is disposed at a bottom of the chamber when the chamber is in the its first rotation position whereat the chamber is usable by an animal, and this internal portion of the chamber is disposed generally at a top of the chamber when the chamber is in its second rotation position whereat the chamber is not usable by an animal. A dump opening is located at a second portion of the chamber, the dump opening being located at or near a top of the chamber when the chamber is in its first-rotation position, and being located at a bottom of the chamber when the chamber is in its second-rotatable position. A moisture impervious, flexible and weighted liner has boarder portions thereof fixed to the interior of the chamber, and has a weighted mid-portion covering the internal portion of the chamber and movable relative thereto. A mass of litter loosely sits on the flexible liner when the chamber is in its first rotation position. Waste separation means within the chamber operates when the chamber is rotated in a first direction between its first-rotatable position and its second-rotatable position to separate animal waste from the mass of litter, whereupon the separated animal waste exits the chamber by way of the waste opening. When the chamber is rotated in a second direction between its first-rotatable position and its second-rotatable position, the mass of litter to exits the chamber by way of the exit opening.

The related art described above discloses animal excrement boxes having rotating drums with filter screens, mechanization, and means for litter exit and entry, and with somewhat complex construction. However, the prior art fails to disclose a rotating drum type litter box that is mounted for free manual rotation and yet is designed to come to rest at a selected position; and which uses an internal screen for selectively picking up waste material exclusive of non-soiled litter, and then depositing, by gravity forces, the waste material into a container that is strategically placed at a functional location adjacent to a waste door in the drum. This simple and highly effective principal is taught in the present invention. The present disclosure distinguishes over the prior art providing heretofore unknown advantages as described in the following summary.

### BRIEF SUMMARY OF THE INVENTION

This disclosure teaches certain benefits in construction and use which give rise to the objectives described below.

The cat litter box, in one form or another, has been used for hundreds of years. Ultimately, it is desired to have such a pet waste depository that is self cleaning, that does not emit odors, and that provides sanitary operation. The present invention meets these needs, but additionally, is much less expensive to manufacture, pack, ship and use as will be shown in the following detailed description. The present invention is a rotational drum type cat litter box that is manually rotated to sift common litter material to capture waste on a screen that is then emptied by opening a door on the side of the drum. It is critical that the screen door be positioned just above and to one side of a receptacle so that when the door is opened, the waste material can fall by its own into the receptacle. This is accomplished by the use of a well designed base that holds both the drum and the receptacle assuring their mutual physical positions. No manual handling of the waste materials need be carried out. The drum, in the preferred embodiment, is separable into two halves, and with the end caps removed, the two halves may be nested to provide a low profile disassembled unit. This enables the apparatus to be packed in a relatively small box and can be shipped at low cost. Reassembly is easily accomplished by the consumer. Operation is highly intuitive.

A primary objective inherent in the above described apparatus and method of use is to provide advantages not taught by the prior art.

Another objective is to provide a cat litter box that reduces human contact with animal waste.

A still further objective is to provide an improved method of use that is simple, sanitary, and effective.

A further objective is to provide such a box that is able to sift litter without the use of mechanization.

A still further objective is to provide such a box that is easily assembled so that it may be compactly shipped to users in a broken-down state thereby reducing shipping and packing costs.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 is a perspective view of the presently described apparatus showing a base, a drum and a waste receptacle;

FIG. 2 is a perspective view of the base thereof;

FIG. 3 is a perspective view of the base with the waste receptacle inserted;

FIG. 4 is a perspective view of the waste receptacle with access door open;

FIG. 5 is a perspective view of a portion of the interior of the drum showing a litter screen and a waste removal portal;

FIG. 6 is a perspective view of a portion of the exterior of the drum showing the waste removal portal, portal door and litter screen; and

FIGS. 7A-7E are concept diagrams of the drum as viewed from one end, showing a method of use for screening and disposing of pet waste; whereby

FIG. 7A is a nominal position of the drum when used by an animal;

FIG. 7B is a position as rotated by 90° clockwise from nominal;

FIG. 7C is a position as rotated by 180° clockwise from nominal;

FIG. 7D is a position as rotated by 270° clockwise from nominal; and

FIG. 7E is as rotated by 360° clockwise to reassume the nominal position.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

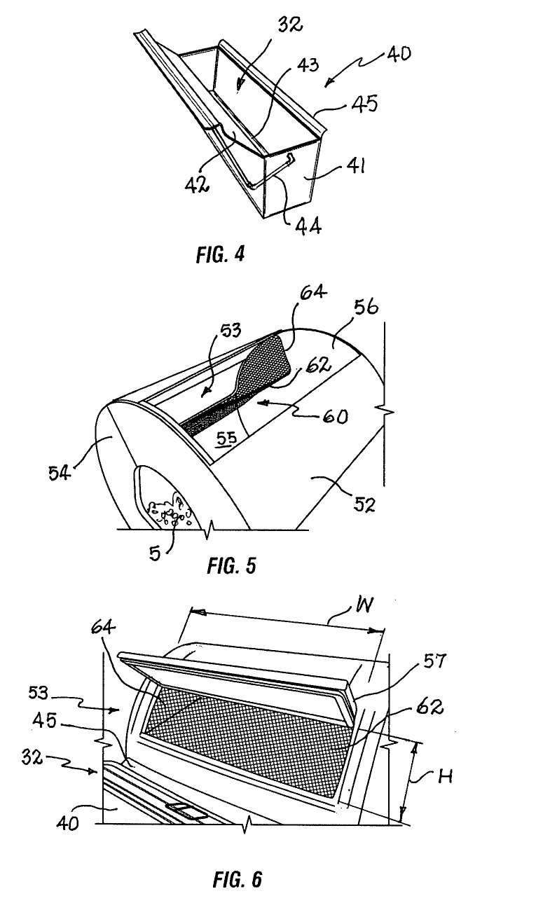

Described now in detail is a pet box apparatus providing rotational sifting of litter material 5 to separate out and dispose of waste material 7. The apparatus may be used for any animal that can be trained to use a litter box, such as cats and dogs. The apparatus uses a support base 10 (FIG. 2) having a concave drum support 20, and adjacent thereto, a receptacle receiver 30. The support base 10, comprises a front strut 12, a rear strut 14, and, between the front and rear struts, a first 16 and second 18 side struts. Struts 12, 14, 16, and 18 form a rectangular frame. The support base 10 further includes a medial strut 17 positioned between the first and second struts 16 and 18. The drum support 20 extends between the medial strut 17 and the second side strut 18. The front strut 12, rear strut 14, first side strut 16 and the medial strut 17 form the receptacle receiver 30 as an open rectangular frame within which a waste receptacle 40 (FIG. 4) of appropriate size is inserted as a tight fit. Preferably, the waste receptacle 40 is a rectangular box with side wall panels 41 and a bottom panel 43 and a hinged door 42 which is fitted for an air-tight seal when closed to eliminate the emanation of odors from the receptacle 40. The length of the receptacle 40 extends over the width W of the screen 60 so that any waste material in the screen 60 will drop into the receptacle 40 and not fall elsewhere. The receptacle 40 may also provide a lip 45 extensive between the receptacle 40 and drum 50 to assure collection of all particulate that may fall from screen 60 toward receptacle 40. See FIG. 6.

A drum 50 rests on the concave drum support 20 and drum 50 and support 20 are in intimate contact over the full range of the surface of support 20. In this way, the drum 50, when rested onto support 20, although not engaged with support 20, but merely resting on it, always is positioned in the same location relative to the receptacle receiver 30. This is important as will be further explained.

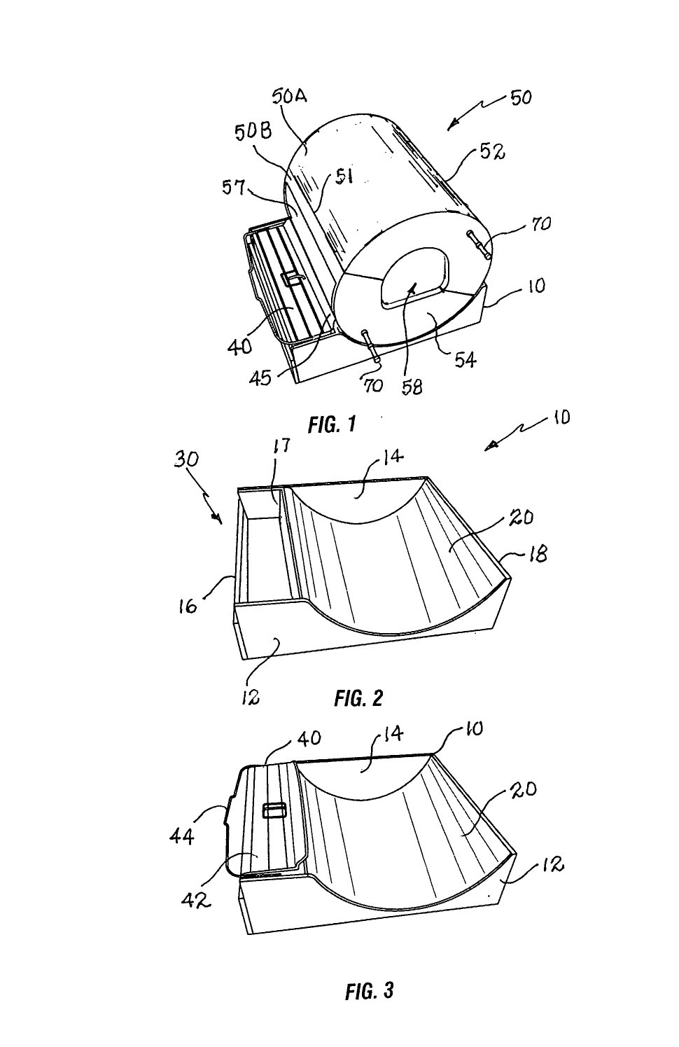

As shown in FIG. 1, the drum 50 is configured with a circular cylindrical wall 52 terminating at opposing front 54 and rear 56 (FIG. 5) end walls. The front end wall 54 provides a pet access portal 58. A litter screen 60 is mounted on an interior surface 55 (FIG. 5) of the cylindrical wall 52 in a position adjacent to a waste disposal portal 53 as best seen in FIGS. 5 and 6. It should be noted that the waste receptacle 40 is positioned within the receptacle receiver 30 so that its entrance 32 is immediately below, and adjacent to, the disposal portal 53 of the drum 50 as best shown in FIG. 6.

Preferably, the litter screen 60 is formed from a flat screening stock material with screen openings therein of such size as to allow a non-clumped animal litter material to pass through the litter screen 60 unimpeded. This action is well described in Flores, U.S. Pat. No. 5,551,375 which is hereby incorporated by reference herein. Preferably, as shown in FIGS. 5 and 6, the litter screen 60 is made up of a first elongate rectangular section 62 having a length approximating a spaced apart distance between the front and rear end walls 54, 56. The first section 62 is bounded on each of two opposing edges by a modified triangular section 64. As shown in FIG. 5 the sections 64 abut the curved interior surface 55 of drum 50.

The waste disposal portal 53 is rectangular, as shown in FIG. 6 with a width “W” approximating the length of the first section 62 of the litter screen 60, and a height “H” sufficient for enabling the waste material 7 to pass through the disposal portal 53 from the screen 60 as will be described.

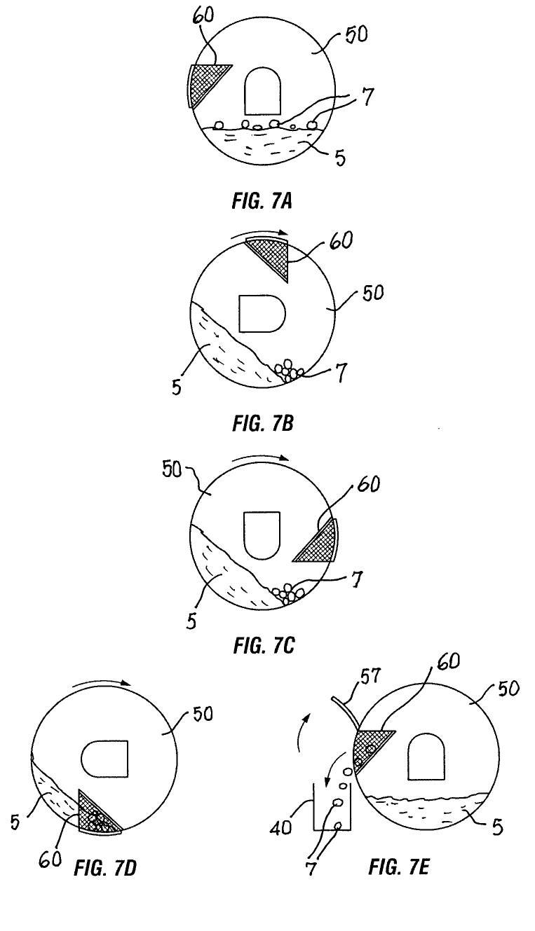

The litter screen 60 is mounted on the interior surface 55 of the cylindrical wall 52 in a position for scooping and sifting the litter material 5 within the drum 50 when the drum 50 is rotated in a selected rotational sense. This process is illustrated by FIGS. 7A though 7D as a sequence of rotational positions. Drum rotation, as depicted in FIGS. 7A-7C shows that heavier material (waste material 7) tends to move to the lowest position in drum 50 during rotation. The screen 60 enters the litter material, as shown in FIG. 7D, and as it moves through the litter material 5 any animal solid waste and any clumped litter (formed from animal urination) is captured between the screen 60 and the cylindrical wall 52. Clean litter 5 is also picked up by screen 60 but is able to move through screen 60 leaving waste material 7 remaining in the screen 60 as shown in FIG. 7E. A waste disposal door 57 is hinged to the cylindrical wall 52 and covers the waste disposal portal 53 during drum rotation. Any form of hinge arrangement may be used and a snap-action friction lock of the door 57 is preferred. When the drum has been rotated one full turn as shown in FIG. 7E, door 57 is opened allowing waste material 7 to drop into waste receptacle 40. Waste receptacle door 42 is open, as shown in FIG. 4 during the receipt of waste material 7 and is thereafter closed to eliminate odors. When the waste receptacle 40 is full, it is emptied into a proper waste container or toilet for ultimate disposal. A handle 44 is attached to the receptacle 40 to enable withdrawal of the receptacle 40 from the receptacle receiver 30 and for carrying the receptacle 40.

Rotation of drum 50 is enabled by the use of two handles 70 mounted on front end wall 54 and extending outwardly therefrom. These handles 70 are manually gripped and used to rotate drum 50 clockwise by exactly one rotation.

The construction of the present invention may, of course, take many forms. Preferably, the front and rear end walls 54 and 56 have machine threads impressed on their circular peripheral edges and the ends of the cylindrical wall 52 has a female thread so that the end walls 54, 56 may be mounted to the cylindrical wall 52 by threaded engagement. Preferably, the drum 50 is an assembly of two half-drums 50A and 50B as shown in FIG. 1; see parting line 51 wherein the two halves 50A and 50B are joined; and such joining may be by any well known technique including common fasteners. In order to pack and ship the present invention efficiently, the two halves 50A and 50B may be separated and nested within the support base 10. Further disassembly and brake-down of the invention can reduce the size of a shipped unit even further.

As described, the method of use of the present apparatus includes; providing the concave support base 10 and, selectively positioning adjacent thereto, the receptacle receiver 30, resting the drum 50 on the support base 10 and placing a waste receptacle 40 into the receptacle receiver 30. The screen 60 is mounted in axial orientation on the inside surface 55 of the cylindrical wall 52 of the drum 50 and a disposal portal is placed in the cylindrical wall 52 adjacent to the screen 60. With a litter material 5 in the drum 50 and with waste material 7 mixed into the material 5, the handles 70 are used to rotate the drum 50 manually thereby moving the screen 60 through the litter material 5 so as to separate the waste material 7 from the litter material 5, the waste material 7 being captured in the screen 60. The drum 50 is further rotated to position the screen 60 at a medial height, as shown in FIGS. 7A and 7E, within the drum 50, in a position immediately adjacent to the waste receptacle 40. The waste door 57 on the cylindrical wall 52 that is positioned over and seals the waste aperture to allow the waste material to drop away from the screen into the waste receptacle.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. An animal waste handling apparatus providing rotational sifting of litter material to separate out waste material, the apparatus comprising: a support base having a concave drum support, and adjacent thereto, a receptacle receiver; a drum resting on the concave surface of the drum support, the drum configured with a circular cylindrical wall terminating at opposing front and rear end walls; the front end wall providing a pet access portal; a litter screen mounted on an interior surface of the cylindrical wall in a position adjacent to a cylindrical wall disposal portal; and a waste receptacle positioned within the receptacle receiver in a position placing an entrance of the waste receptacle immediately below and adjacent to the disposal portal.

2. The apparatus of claim 1 wherein the support base comprises a front strut, a rear strut, and, between the front and rear struts, a pair of spaced apart side struts forming a frame, the frame further including a medial strut positioned between the side struts, the drum support extending between the medial strut and a first one of the side struts, the waste receptacle positioned tightly between the medial strut and a second one of the side struts.

3. The apparatus of claim 1 wherein the litter screen is formed from a flat screen stock with screen openings therein of such size as to allow a non-clumped animal litter material to pass through the litter screen unimpeded.

4. The apparatus of claim 3 wherein the litter screen provides a first elongate rectangular section having a length approximating a spaced apart distance between the front and rear end walls; the first section bounded on each of two opposing edges by a triangular section.

5. The apparatus of claim 4 wherein the waste disposal portal is rectangular with a width approximating the length of the rectangular section of the litter screen and a height sufficient for enabling the waste material to pass through the disposal portal.

6. The apparatus of claim 4 wherein the litter screen is positioned on the cylindrical wall in a position for scooping and sifting the litter material within the drum when the drum is rotated in a selected rotational sense.

7. The apparatus of claim 1 wherein the front and rear end walls of the drum are threadedly engaged with the cylindrical wall.

8. The apparatus of claim 1 wherein the drum is an assembly of two separable parts wherein each one of the parts comprises about one half of the drum.

9. The apparatus of claim 1 wherein the front end wall of the drum provides two handles extending outwardly therefrom.

10. An animal waste handling apparatus comprising: a cylindrical drum rotational on a concave surface, the cylindrical drum uniquely positioned by the concave surface relative to a waste receptacle held in a fixed fixture, the drum providing, on a side wall thereof, a waste portal positionable by selective rotation of the drum into a position wherein animal wastes are able to drop directly from a sifting screen inside the cylindrical drum into the waste receptacle by uncovering the waste portal.

11. A method of use of an animal waste handling apparatus providing rotational sifting of litter material within the pet box, the method comprising the steps of:
a) providing a concave support base and, selectively positioned adjacent thereto, a receptacle receiver;
b) resting a drum having a cylindrical wall on the support base and placing a waste receptacle into the receptacle receiver;
c) mounting a screen in axial orientation on an inside surface of the cylindrical wall of the drum and placing a disposal portal in the cylindrical wall adjacent to the screen;
d) rotating the drum manually thereby moving the screen through the litter material so as to separate waste material within the litter material from the litter material, the waste material being captured in the screen;
e) rotating the drum to position the screen at a medial height within the drum adjacent to the waste receptacle; and
f) opening a door on the cylindrical wall over the waste aperture to allow the waste material to drop away from the screen into the waste receptacle.
